(19) United States
(12) Patent Application Publication
(10) Pub. No.: US 2026/0270080 A1
(43) Pub. Date: Sep. 10, 2026

(54) KEY GENERATION MANAGEMENT DEVICE AND SIGNATURE VERIFICATION SYSTEM

(71) Applicant: Astemo, Ltd., Chiyoda-ku, Tokyo (JP)

(72) Inventors: Shugo MIKAMI, Hitachinaka-shi, Ibaraki (JP); Yasuhiro FUJII, Hitachinaka-shi, Ibaraki (JP); Teruaki NOMURA, Hitachinaka-shi, Ibaraki (JP); Mikio KATAOKA, Hitachinaka-shi, Ibaraki (JP)

(73) Assignee: Astemo, Ltd., Chiyoda-ku, Tokyo (JP)

(21) Appl. No.: 19/166,180

(22) PCT Filed: May 24, 2023
(86) PCT No.: PCT/JP2023/019293

§ 371 Date: Sep. 17, 2025

(51) Int. Cl. H04L 9/32; H04L 9/08

(52) U.S. Cl. CPC H04L 9/3247; H04L 9/0866

(57) ABSTRACT

An object is to enable specification of an in-vehicle electronic device that is a signer from a digital signature in a case where authenticity of the digital signature cannot be verified while protecting privacy. A key generation management device 11 generates and manages a signature key used for generation of a signature to be added to vehicle data transmitted from an in-vehicle electronic device 21. The key generation management device 11 includes a key generation unit 102 that generates a plurality of signature keys having different values and a verification key corresponding to the plurality of signature keys by using a group signature scheme, a communication unit 101 that receives the signature generated by the in-vehicle electronic device 21 using the signature key and subjected to processing of verifying authenticity of the signature by using the verification key, and a signer verification processing unit 103 that performs signer verification processing of specifying the in-vehicle electronic device 21 corresponding to the signer who has generated the signature on the signature received by the communication unit 101.

### TECHNICAL FIELD

The present invention relates to a key generation management device and a signature verification system.

### BACKGROUND ART

In a vehicle such as an automobile, a plurality of in-vehicle electronic devices called electric control units (ECUs) that perform functions such as engine control, brake control, and safety control are mounted. Such functions are implemented by in-vehicle software installed on the ECUs. In recent years, in order to implement functions such as automated driving and driving assistance, in-vehicle electronic devices that perform such functions are connected to each other via an in-vehicle network and cooperate with each other, and are also connected to a server outside a vehicle. A vehicle having such a network connection function is called a connected car, and transmits vehicle data such as location information, traveling history, and behavior information of the vehicle from an in-vehicle electronic device to a server outside the vehicle. The server that has received the vehicle data analyzes the vehicle data and transmits an analysis result as a traveling proposal to the in-vehicle electronic device. It is expected that a service such as automated driving or driving assistance via such a network will become increasingly widespread in the future.

Since vehicles are also used as means of transportation across regions or countries, it is desirable that the service can be continuously used even after crossing the border. In order to implement the service via such a network, it is important to ensure that the vehicle data is authentic data transmitted from an authorized vehicle, that is, the vehicle data has not been falsified. In order to guarantee the authenticity of the vehicle data, the vehicle data is usually added with a digital signature and transmitted to a server of a service provider that provides and manages the service. The service provider verifies the digital signature added to the vehicle data.

PTL 1 is known as a technology for adding a digital signature to vehicle data and verifying the signature. PTL 1 describes a method in which a signature key used for adding a digital signature is the same in all vehicles, and a method in which an identifier of a vehicle is used in combination with the method.

### CITATION LIST

### Patent Literature

PTL 1: JP 2020-201807 A

### SUMMARY OF INVENTION

### Technical Problem

Since a general digital signature is uniquely associated with a signer who is an entity that has generated the digital signature, a service provider who performs signature verification grasps information that can specify the signer. That is, a general digital signature has a privacy problem that a service provider can specify an individual who is a transmission source of vehicle data.

In the method of using the same signature key in all the vehicles described in PTL 1, when the authenticity of the digital signature cannot be verified, it is difficult to specify an in-vehicle electronic device based on the digital signature. As a result, in the method of using the same signature key in all the vehicles described in PTL 1, it is difficult to cope with an abnormality in which the authenticity of the digital signature cannot be verified. In addition, the method of using the identifier of the vehicle in combination described in PTL 1 has the above-described privacy problem, and the service provider is separately required to take measures to comply with laws and regulations concerning the handling of personal information.

The present invention has been made in view of the above, and an object of the present invention is to enable specification of an in-vehicle electronic device that is a signer based on a digital signature in a case where authenticity of the digital signature cannot be verified while protecting privacy.

### Solution to Problem

In order to solve the above problem, a key generation management device of the present invention is a key generation management device that generates and manages a signature key used for generation of a signature to be added to vehicle data transmitted from an in-vehicle electronic device to the outside of a vehicle, the key generation management device including: a key generation unit that generates a plurality of signature keys having different values and a verification key corresponding to the plurality of signature keys by using a group signature scheme; a communication unit that receives the signature generated by the in-vehicle electronic device using the signature key and subjected to signature verification processing of verifying authenticity of the signature by using the verification key; and a signer verification processing unit that performs signer verification processing of specifying the in-vehicle electronic device corresponding to a signer who has generated the signature on the signature received by the communication unit.

### Advantageous Effects of Invention

According to the present invention, it is possible to specify an in-vehicle electronic device that is a signer based on a digital signature in a case where authenticity of the digital signature cannot be verified while protecting privacy.

Problems, configurations, and effects other than the above will be clarified by the following description of the embodiment.

### BRIEF DESCRIPTION OF DRAWINGS

FIG. 1 is a diagram illustrating a configuration of a signature verification system of the present embodiment.

FIG. 2 is a diagram illustrating a hardware configuration of each vehicle illustrated in FIG. 1.

FIG. 3 is a diagram illustrating a hardware configuration of an in-vehicle electronic device illustrated in FIG. 1.

FIG. 4 is a diagram illustrating a hardware configuration of each of a key generation management device and a signature verification device illustrated in FIG. 1.

FIG. 5 is a flowchart illustrating processing performed by the signature verification system illustrated in FIG. 1.

FIG. 6 is a flowchart illustrating details of key generation processing of S501 illustrated in FIG. 5.

FIG. 7 is a flowchart illustrating details of key distribution processing of S502 illustrated in FIG. 5.

FIG. 8 is a flowchart illustrating details of signature generation processing of S503 illustrated in FIG. 5.

FIG. 9 is a flowchart illustrating details of signature verification processing of S504 illustrated in FIG. 5.

FIG. 10 is a flowchart illustrating details of signer verification processing of S505 illustrated in FIG. 5.

FIG. 11 is a diagram illustrating an example of a user screen displayed for a user by the key generation management device illustrated in FIG. 1.

FIG. 12 is a diagram for describing vehicle information and key-generation-related information stored in the key generation management device illustrated in FIG. 1.

FIG. 13 is a diagram for describing determination processing in the key generation management device based on a relationship between a result of the signature verification processing and a result of the signer verification processing.

### DESCRIPTION OF EMBODIMENTS

Hereinafter, embodiments of the present invention will be described with reference to the drawings. Configurations or functions denoted by the same reference signs in the respective embodiments are similar configurations or functions in the respective embodiments, and a description thereof will be omitted unless otherwise specified.

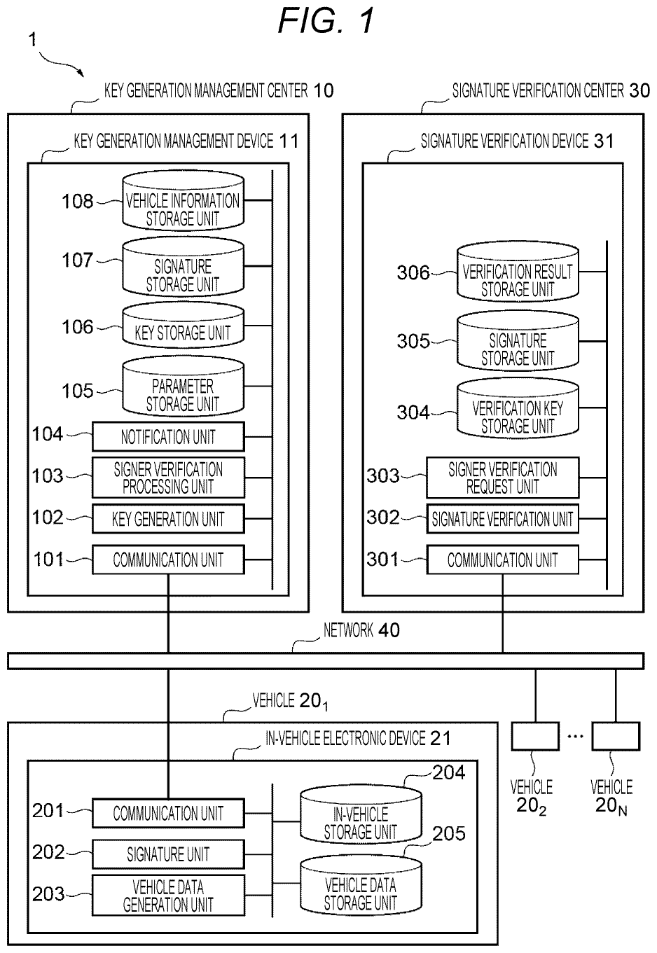

FIG. 1 is a diagram illustrating a configuration of a signature verification system 1 of the present embodiment.

The signature verification system 1 includes a key generation management center 10, vehicles 20₁ to 20_{N}, a signature verification center 30, and a network 40.

The key generation management center 10 includes a key generation management device 11 which is a computer that generates and distributes a signature key and a verification key and verifies a signer.

The number of vehicles 20₁ to 20_{N} is not particularly limited. In the present embodiment, in a case where it is not necessary to particularly distinguish each of the vehicles 20₁ to 20_{N}, subscripts of the vehicles 20₁ to 20_{N} are omitted, and the vehicles 20₁ to 20_{N} are also simply referred to as the vehicle 20. The vehicle 20 includes an in-vehicle electronic device 21 that generates a digital signature (hereinafter, also referred to as “signature”) and adds the digital signature to vehicle data.

The signature verification center 30 is a part of a service provider that provides a service such as automated driving or driving assistance to the vehicle 20 via the network 40. The signature verification center 30 includes a signature verification device 31 which is a computer that performs signature verification and requests for signer verification.

The key generation management device 11 generates and manages the signature key used for generation of the signature to be added to the vehicle data transmitted from the in-vehicle electronic device 21 to the outside of the vehicle 20. The key generation management device 11 transmits each of a plurality of generated signature keys to the in-vehicle electronic device 21, and transmits the generated verification key to the signature verification device 31. The key generation management device 11 performs, on the signature transmitted from the signature verification device 31, signer verification processing of specifying the in-vehicle electronic device 21 corresponding to the signer who has generated the signature.

The key generation management device 11 includes a communication unit 101 that communicates with the network 40, a key generation unit 102 that generates the signature key and the verification key, a signer verification processing unit 103 that performs the signer verification processing, and a notification unit 104 that notifies a user of a result of the signer verification processing. Further, the key generation management device 11 includes a parameter storage unit 105 that stores a parameter used to generate the signature key and the verification key by the key generation unit 102, and a key storage unit 106 that stores the verification key generated by the key generation unit 102. Further, the key generation management device 11 includes a signature storage unit 107 that stores the signature transmitted from the signature verification device 31, and a vehicle information storage unit 108 that stores vehicle information including the signature key generated by the key generation unit 102 and identification information of the in-vehicle electronic device 21 that indicates a transmission destination of the signature key.

The key generation unit 102 generates a plurality of signature keys having different values and a verification key corresponding to the plurality of signature keys by using a group signature scheme. The key generation unit 102 generates the plurality of signature keys by using a plurality of different parameters.

The communication unit 101 receives, from the signature verification device 31, the signature generated by the in-vehicle electronic device 21 using the signature key and subjected to signature verification processing of verifying authenticity of the signature by using the verification key. For example, the communication unit 101 receives, from the signature verification device 31, the signature whose authenticity has not been verified by the signature verification processing in the signature verification device 31.

The signer verification processing unit 103 performs, on the signature received by the communication unit 101, the signer verification processing of specifying the in-vehicle electronic device 21 corresponding to the signer who has generated the signature. In the signer verification processing, the signer verification processing unit 103 specifies which of the plurality of parameters is used to generate the signature key used to generate the signature received by the communication unit 101, thereby specifying the in-vehicle electronic device 21 corresponding to the signer.

In a case where the in-vehicle electronic device 21 corresponding to the signer has not been specified by the signer verification processing, the signer verification processing unit 103 determines that there is a possibility that the vehicle data to which the signature received by the communication unit 101 is added has been falsified by a cyberattack. In a case where the in-vehicle electronic device 21 corresponding to the signer has been specified by the signer verification processing, the signer verification processing unit 103 determines that there is a possibility that the vehicle data to which the signature received by the communication unit 101 is added includes a communication error.

The notification unit 104 displays a result of the signer verification processing on a display to notify the user of the result. In addition, in a case where it is determined that there is a possibility that the vehicle data to which the signature received by the communication unit 101 is added has been falsified by a cyberattack, the notification unit 104 makes a notification of the determination result to the outside of the key generation management device 11. For example, the notification unit 104 notifies the key generation management center 10, a security management department of the service provider, or the like, of the determination result. In addition, in a case where it is determined that there is a possibility that the vehicle data to which the signature received by the communication unit 101 is added includes a communication error, the notification unit 104 makes a notification of the determination result to the outside of the key generation management device 11. For example, the notification unit 104 notifies a department in charge of the service provider that manages a communication status of the vehicle 20, the corresponding vehicle 20, or the like, of the determination result.

The communication unit 101 may receive, from the signature verification device 31, the signature whose authenticity has been verified by the signature verification processing in the signature verification device 31. In this case, the signer verification processing unit 103 can specify the in-vehicle electronic device 21 corresponding to the signer by the signer verification processing.

The in-vehicle electronic device 21 generates the signature by using the signature key transmitted from the key generation management device 11, adds the signature to the vehicle data, and transmits the signature added to the vehicle data to the signature verification device 31.

The in-vehicle electronic device 21 includes a communication unit 201 that communicates with the network 40, a signature unit 202 that generates the signature using the signature key stored in an in-vehicle storage unit 204 and adds the signature to the vehicle data, and a vehicle data generation unit 203 that generates the vehicle data. Furthermore, the in-vehicle electronic device 21 includes the in-vehicle storage unit 204 that stores the signature key transmitted from the key generation management device 11, and a vehicle data storage unit 205 that stores the vehicle data generated by the vehicle data generation unit 203.

The signature verification device 31 is connected to the in-vehicle electronic device 21 and the key generation management device 11 via the network 40, and performs the signature verification processing of verifying the authenticity of the signature. Specifically, the signature verification device 31 performs, on the signature transmitted from the in-vehicle electronic device 21, the signature verification processing by using the verification key transmitted from the key generation management device 11. The signature verification device 31 determines whether or not execution of the signer verification processing is necessary. The signature verification device 31 transmits the signature for which it is determined that the execution of the signer verification processing is necessary to the key generation management device 11, and requests the key generation management device 11 to perform signer verification.

The signature verification device 31 includes a communication unit 301 that communicates with the network 40, a signature verification unit 302 that performs the signature verification processing on the signature transmitted from the in-vehicle electronic device 21, and a signer verification request unit 303 that requests the key generation management device 11 to perform signer verification. Furthermore, the signature verification device 31 includes a verification key storage unit 304 that stores the verification key transmitted from the key generation management device 11, a signature storage unit 305 that stores the signature transmitted from the in-vehicle electronic device 21, and a verification result storage unit 306 that stores a result of the signature verification processing.

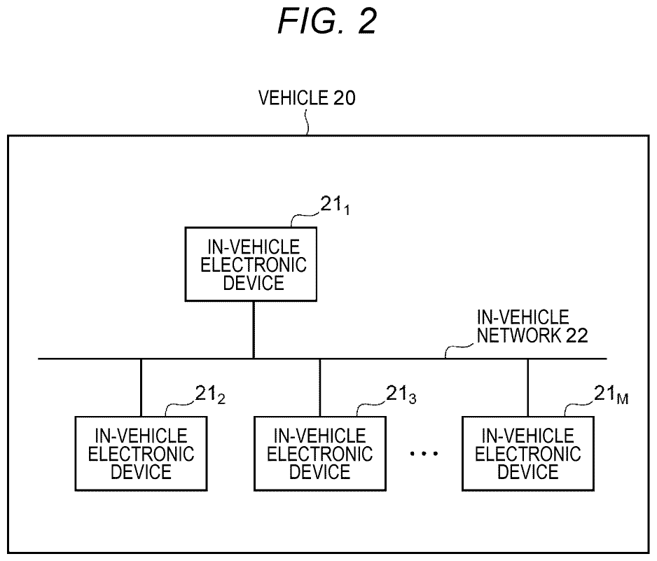

FIG. 2 is a diagram illustrating a hardware configuration of each of the vehicles 20₁ to 20_{N} illustrated in FIG. 1.

In the vehicle 20, one or more in-vehicle electronic devices 21₁ to 21_{M} are mutually connected by an in-vehicle network 22. The number of in-vehicle electronic devices 21₁ to 21_{M} is an arbitrary number and is not particularly limited. Among the in-vehicle electronic devices 21₁ to 21_{M}, there may be a master device that controls other in-vehicle electronic devices among the in-vehicle electronic devices 21₁ to 21_{M}, a slave device that receives an instruction from other in-vehicle electronic devices among the in-vehicle electronic devices 21₁ to 21_{M}, a proxy device or a gateway device that intermediates and converts communication of two or more other in-vehicle electronic devices among the in-vehicle electronic devices 21₁ to 21_{M}, and the like. In the present embodiment, in a case where it is not necessary to particularly distinguish each of the in-vehicle electronic devices 21₁ to 21_{M}, subscripts of the in-vehicle electronic devices 21₁ to 21_{M} are omitted, and the in-vehicle electronic devices 21₁ to 21_{M} are also simply referred to as the in-vehicle electronic device 21. The in-vehicle network 22 is, for example, a control area network (CAN) or Ethernet, but is not limited thereto. There may be a plurality of in-vehicle networks 22 in the vehicle 20.

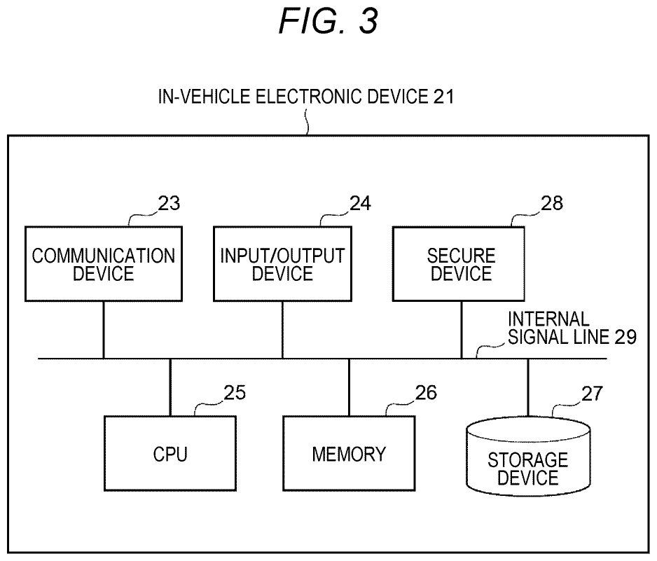

FIG. 3 is a diagram illustrating a hardware configuration of the in-vehicle electronic device 21 illustrated in FIG. 1.

The in-vehicle electronic device 21 has a configuration in which a communication device 23, an input/output device 24, a central processing unit (CPU) 25, a memory 26, a storage device 27, and a secure device 28 are mutually connected by an internal signal line 29 such as a bus. The secure device 28 may be, for example, a device having a storage area that is physically non-rewritable, a storage area that is rewritable only once, or a storage area in which access control such as authentication of a user or a process is set. The secure device 28 may be a device that stores a key for encryption or decryption, a digital signature for verifying software or the like, an electronic certificate, a setting value, a verification value, identification information, or the like, and performs encryption/decryption processing, verification processing, signature addition processing, or the like, like a hardware security module (HSM). The communication device 23 is connected to the network 40 and transmits and receives data.

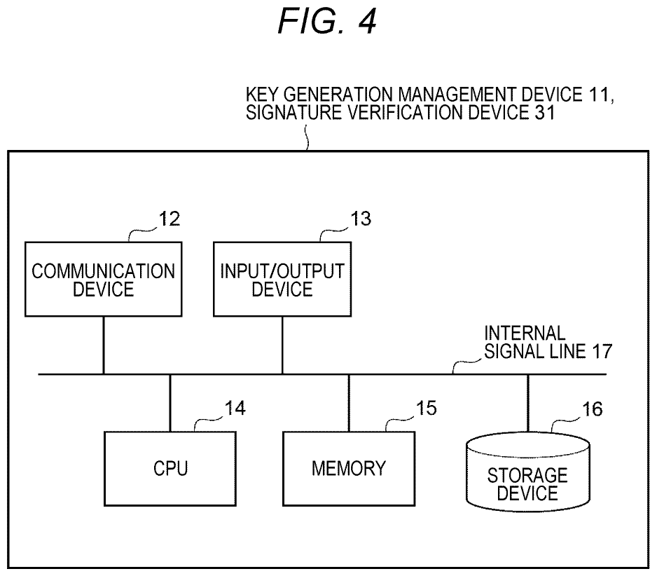

FIG. 4 is a diagram illustrating a hardware configuration of each of the key generation management device 11 and the signature verification device 31 illustrated in FIG. 1.

The hardware configurations of the key generation management device 11 and the hardware configuration of the signature verification device 31 may be the same as each other. Each of the key generation management device 11 and the signature verification device 31 has a configuration in which a communication device 12, an input/output device 13, a CPU 14, a memory 15, and a storage device 16 are connected to each other via an internal signal line 17. The input/output device 13 is, for example, a keyboard, a mouse, a touch panel, a numeric keypad, a scanner, a microphone, a sensor, a display, a printer, or a speaker. The communication device 12 is connected to the network 40 and transmits and receives data.

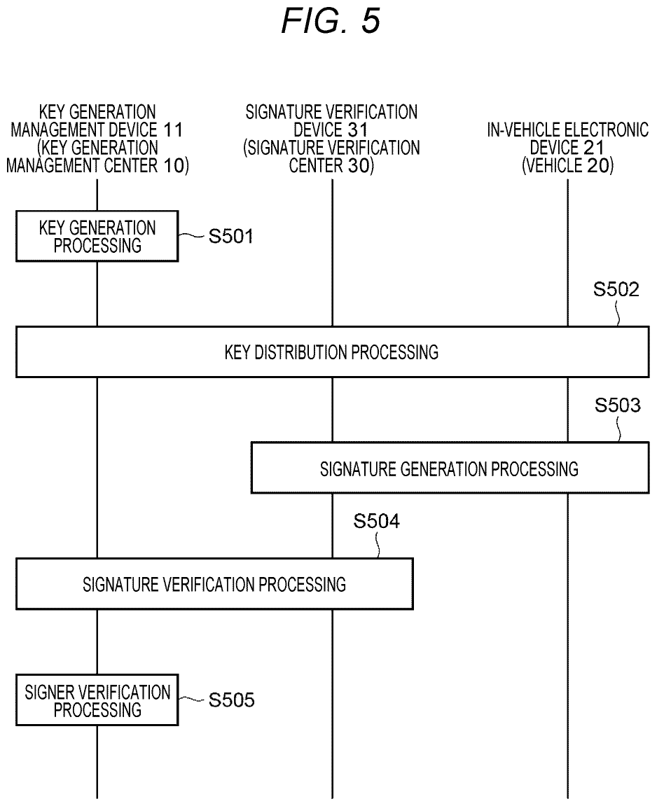

FIG. 5 is a flowchart illustrating processing performed by the signature verification system 1 illustrated in FIG. 1.

The flowchart illustrated in FIG. 5 is executed by programs stored in the respective storage devices 16 and 27 of the key generation management device 11, the signature verification device 31, and the in-vehicle electronic device 21 being loaded into the memories 15 and 26 and executed by the CPUs 14 and 25. The programs stored in the respective storage devices 16 and 27 may be introduced into the storage devices 16 and 27 at appropriate timings via an external recording medium or a communication medium (a network or a transmission wave propagating through the network).

First, the key generation management device 11 performs key generation processing of generating the signature key and the verification key by using the group signature scheme (S501). Next, the key generation management device 11, the in-vehicle electronic device 21, and the signature verification device 31 perform key distribution processing of distributing the generated signature key and verification key (S502). Next, the in-vehicle electronic device 21 and the signature verification device 31 perform signature generation processing of generating the signature to be added to the vehicle data by using the signature key (S503). Next, the key generation management device 11 and the signature verification device 31 perform the signature verification processing of verifying the authenticity of the signature by using the verification key (S504). Next, the key generation management device 11 performs the signer verification processing of specifying the in-vehicle electronic device 21 corresponding to the signer who has generated the signature (S505).

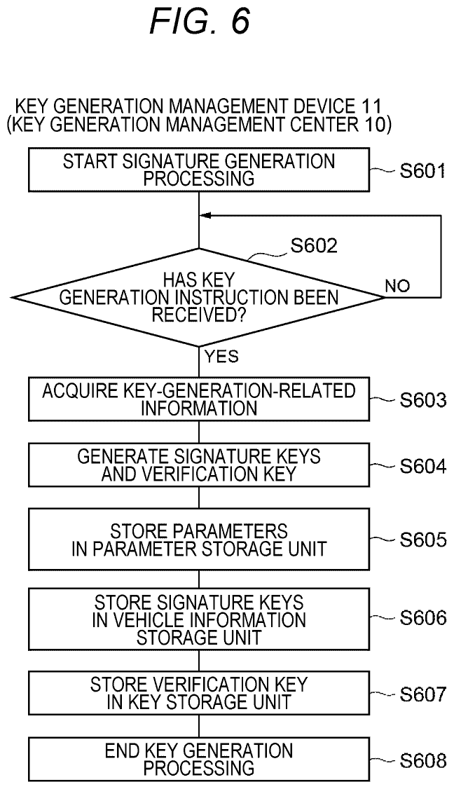

FIG. 6 is a flowchart illustrating details of the key generation processing of S501 illustrated in FIG. 5.

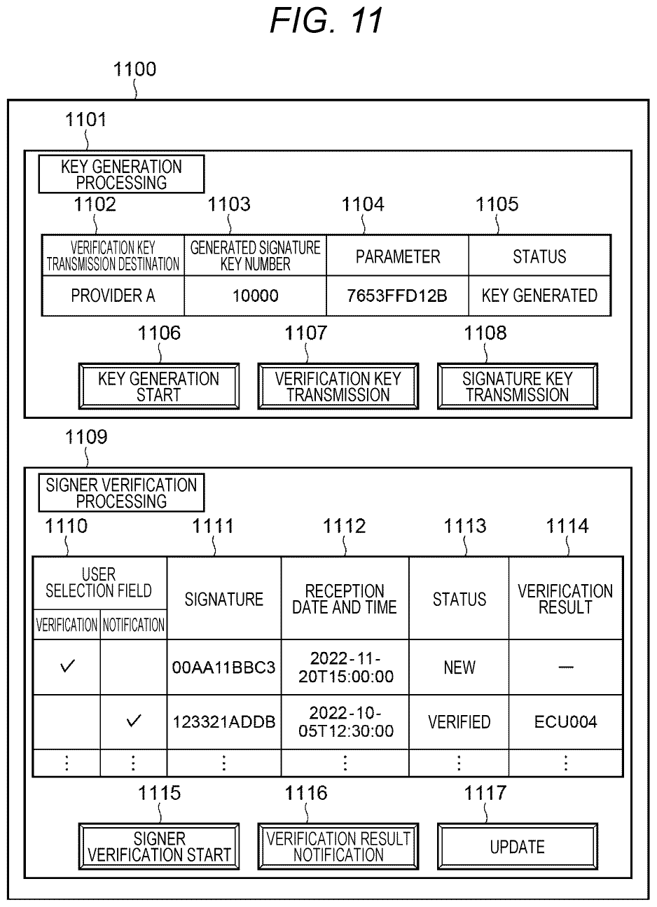

First, the key generation management device 11 starts the key generation processing (S601). Next, the key generation management device 11 determines whether or not a key generation instruction has been received (S602). The key generation management device 11 may receive the key generation instruction input by the user operating the input/output device 13 such as a touch screen display, a keyboard, or a mouse. An example of a user screen for the user to input the key generation instruction is described below with reference to FIG. 11. As another example, the key generation management device 11 may receive the key generation instruction input via an external storage medium such as a digital versatile disc (DVD) or a universal serial bus (USB) memory, or may receive the key generation instruction input via a network from another device (not illustrated) in the key generation management center 10 or the department.

In a case where it is determined that the key generation instruction has not been received, the key generation management device 11 returns to the processing of S602. On the other hand, in a case where it is determined that the key generation instruction has been received, the key generation management device 11 acquires key-generation-related information included in the key generation instruction (S603). The key generation information includes information regarding a transmission destination of the verification key, the number of generated signature keys, and the parameter used for generation of the signature key and the verification key. The information regarding the transmission destination of the verification key is, for example, a name, an address, an identifier, and the like of the transmission destination of the verification key. The parameter is a random number, a seed, a fixed value, an algorithm name, a variable value, a public value, a secret value, or the like. The key-generation-related information is not limited thereto, and may be a combination thereof.

Next, the key generation management device 11 generates the signature keys and the verification key (S604). The key generation management device 11 generates the plurality of signature keys having different values and the verification key corresponding to the plurality of signature keys by using the group signature scheme. The group signature scheme is a type of public key encryption which is an encryption scheme in which the verification key and the signature key have different values. The group signature scheme is an encryption scheme based on, for example, pairing computation that computes a mapping from a set of two points on an elliptic curve to a finite field. The group signature scheme is an encryption scheme in which a relationship between the verification key and the signature keys is 1 to n. In the present embodiment, in the processing of S604, the key generation management device 11 generates the plurality of signature keys by using the plurality of (corresponding to the number of generated signature keys) parameters acquired in the processing of S603, and generates one verification key.

Next, the key generation management device 11 stores the parameters used to generate the signature keys and the verification key in the processing of S604 in the parameter storage unit 105 (S605). In the processing of S605, the key generation management device 11 may store the key-generation-related information other than the parameters in the parameter storage unit 105. Next, the key generation management device 11 stores the signature keys generated in the processing of S604 in the vehicle information storage unit 108 (S606). Next, the key generation management device 11 stores the verification key generated in the processing of S604 in the key storage unit 106 (S607). Then, the key generation management device 11 ends the key generation processing (S608). The steps of processing of S605, S606, and S607 may be performed in any order.

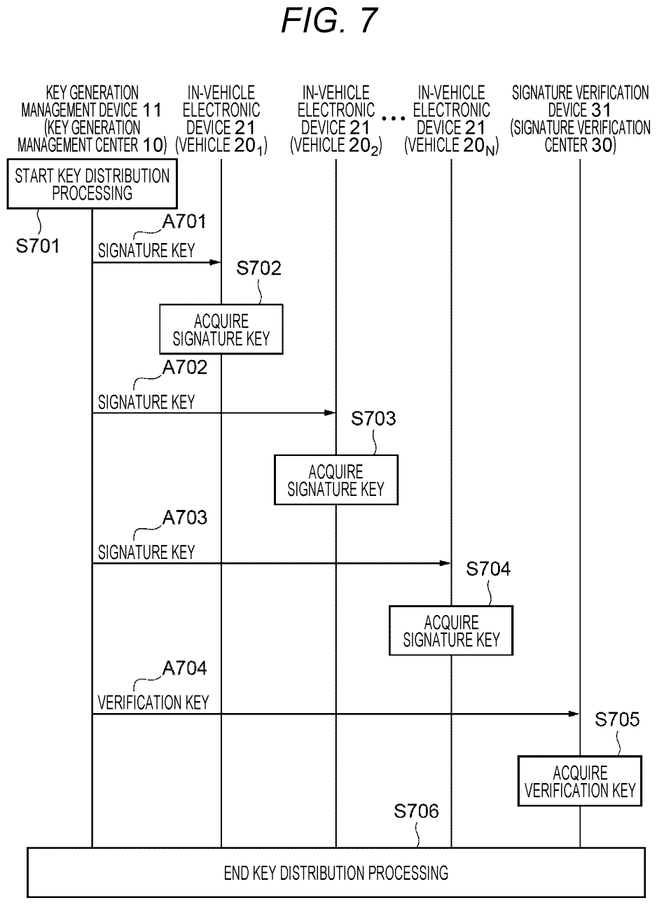

FIG. 7 is a flowchart illustrating details of the key distribution processing of S502 illustrated in FIG. 5.

First, the key generation management device 11 starts the key distribution processing (S701). The key generation management device 11 transmits the signature keys (A701 to A703) to the in-vehicle electronic devices 21 to which the generated signature keys are assigned among the in-vehicle electronic devices 21 as the transmission destinations of the signature keys indicated in the vehicle information stored in the vehicle information storage unit 108 via the network 40. Further, the key generation management device 11 transmits the verification key (A704) stored in the key storage unit 106 to the transmission destination of the verification key included in the key-generation-related information via the network 40.

Here, the network 40 may be a wireless communication network such as long term evolution (LTE), 4G, 5G, wireless fidelity (Wi-Fi), or Bluetooth, or may be a wired local area network (LAN) or the like. Furthermore, in the network 40, a communication path may be encrypted, and one-way authentication or mutual authentication may be performed by a communication protocol such as Security Architecture for Internet Protocol (IPsec), Secure Socket Layer (SSL), Transport Layer Security (TLS), or Secure Shell (SSH).

Next, the respective in-vehicle electronic devices 21 of the vehicles 20₁ to 20_{N} acquire the signature keys (A701 to A703) (S702 to S704). The communication units 201 of the respective in-vehicle electronic devices 21 receive the signature keys (A701 to A703) from the network 40. The in-vehicle storage units 204 of the respective in-vehicle electronic devices 21 store the signature keys (A701 to A703) received by the communication units 201 of the respective in-vehicle electronic devices 21. Next, the signature verification device 31 acquires the verification key (A704) (S705). The communication unit 301 of the signature verification device 31 receives the verification key (A704) from the network 40. The verification key storage unit 304 of the signature verification device 31 stores the verification key (A704) received by the communication unit 301. Then, the key generation management device 11, the in-vehicle electronic device 21, and the signature verification device 31 end the key distribution processing (S706). The steps of processing of S702 to S705 may be performed in an arbitrary order or may be performed simultaneously in parallel.

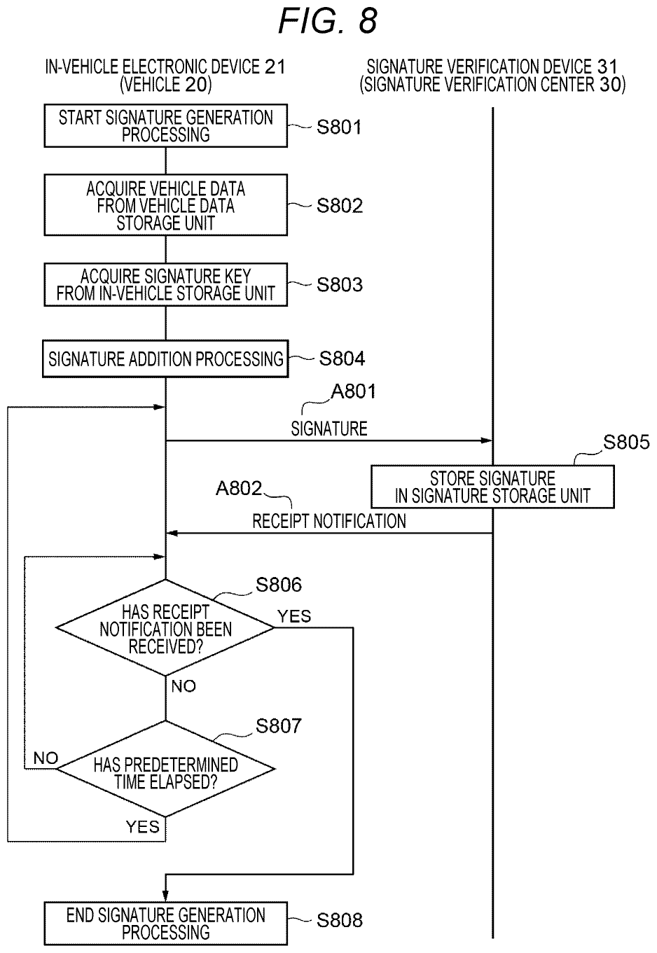

FIG. 8 is a flowchart illustrating details of the signature generation processing of S503 illustrated in FIG. 5.

First, the in-vehicle electronic device 21 starts the signature generation processing (S801). The signature generation processing may be started when the vehicle data is generated, or may be started when a predetermined number of pieces of vehicle data are generated. Alternatively, the signature generation processing may be started when an available capacity of the vehicle data storage unit 205 falls below a predetermined value, or may be started when a predetermined time has elapsed. Alternatively, the signature generation processing may be started when a band of the network 40 is available, may be started when the vehicle 20 stops, or may be started when a processing load of the in-vehicle electronic device 21 falls below a predetermined value. A timing at which the signature generation processing is started is not limited thereto, and may be a combination thereof.

Next, the in-vehicle electronic device 21 acquires the vehicle data to be signed from the vehicle data storage unit 205 (S802). Next, the in-vehicle electronic device 21 acquires the signature key from the in-vehicle storage unit 204 (S803). Next, the in-vehicle electronic device 21 generates the signature by using the signature key in the signature unit 202, and adds the generated signature to the vehicle data (S804). Then, the in-vehicle electronic device 21 transmits the signature (A801) added to the vehicle data to the signature verification device 31 via the network 40.

Next, the signature verification device 31 stores the signature (A801) transmitted from the in-vehicle electronic device 21 in the signature storage unit 305 (S805). Next, the signature verification device 31 transmits a receipt notification (A802) for notifying that the signature (A801) has been received to the in-vehicle electronic device 21 via the network 40.

Next, the in-vehicle electronic device 21 determines whether or not the receipt notification (A802) has been received (S806). In a case where it is determined that the receipt notification (A802) has been received, the in-vehicle electronic device 21 ends the signature generation processing (S808). On the other hand, in a case where it is determined that the receipt notification (A802) has not been received, the in-vehicle electronic device 21 determines whether or not a predetermined time has elapsed since the transmission of the signature (A801) (S807). In a case where it is determined that the predetermined time has elapsed, the in-vehicle electronic device 21 returns to transmission processing for the signature (A801). On the other hand, in a case where it is determined that the predetermined time has not elapsed, the in-vehicle electronic device 21 returns to the processing of S806. The steps of processing of S802 and S803 may be performed in an arbitrary order.

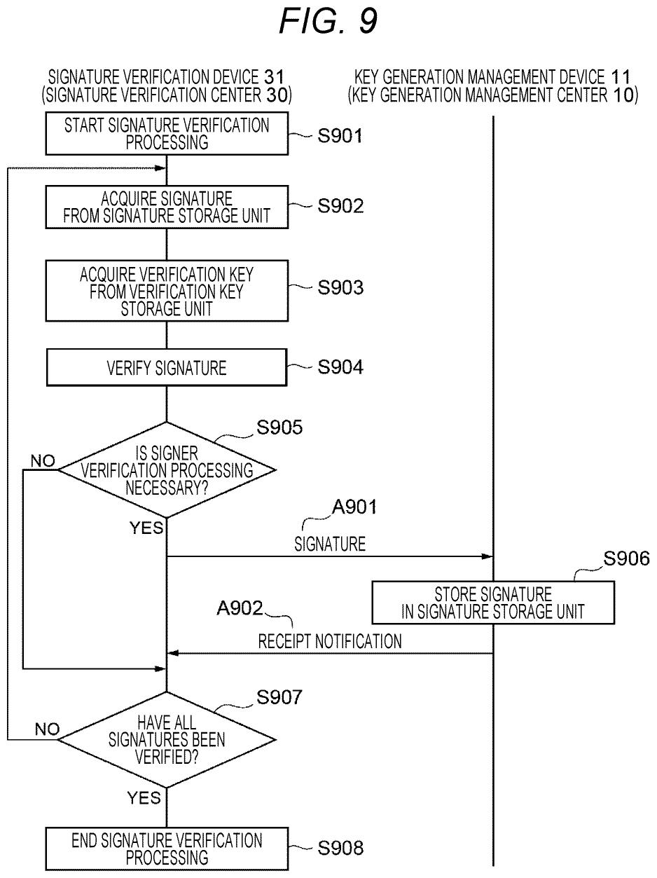

FIG. 9 is a flowchart illustrating details of the signature verification processing of S504 illustrated in FIG. 5.

First, the signature verification device 31 starts the signature verification processing (S901). The signature verification processing may be started when a predetermined time has elapsed, may be started when a predetermined number of signatures are stored in the signature storage unit 305, or may be started when the signature is received from the vehicle 20. A timing at which the signature verification processing is started is not limited thereto, and may be a combination thereof.

Next, the signature verification device 31 acquires the signature from the signature storage unit 305 (S902). Next, the signature verification device 31 acquires the verification key from the verification key storage unit 304 (S903). Next, the signature verification device 31 verifies the authenticity of the signature by using the verification key (S904). Next, the signature verification device 31 determines whether or not the execution of the signer verification processing is necessary (S905).

As an example of a case where the execution of the signer verification processing is necessary, there is a case where the authenticity of the signature cannot be verified in the processing of S904, such as a case where a signature verification result indicates a mismatch. In this case, the vehicle data to which the signature whose authenticity has not been verified is added is used for notification and handling for a security measure. The notification and handling for a security measure are, for example, specification of the in-vehicle electronic device 21 that is subjected to a cyberattack, analysis of a tactic, a technology, or a procedure used in the attack, notification of information including specification of another in-vehicle electronic device 21 that may be subjected to the same attack, planning of a specific measure, and the like.

Furthermore, in a case where the authenticity of the signature has not been verified in the processing of S904, there is a possibility that the vehicle data to which the signature whose authenticity has not been verified is added includes a communication error. In this case, the vehicle data is used for notification and handling for confirming the communication status of the vehicle 20 and notification and handling for a security measure.

Furthermore, as another example of a case where the execution of the signer verification processing is necessary, there is a case where the authenticity of the signature has been verified in the processing of S904. In this case, the vehicle data to which the signature whose authenticity has been verified is added is collected in the server of the service provider after specifying the in-vehicle electronic device 21 in order to manage a state of the vehicle 20 that is necessary for the service provider to provide the service. The collected vehicle data is accumulated in the server as a log of the vehicle 20, and is used for detecting a failure of each component of the vehicle 20, estimating the degree of wear or the degree of failure of each component, predicting a failure of each component, and the like.

The signature verification device 31 may determine that the execution of the signer verification processing is necessary regardless of a result of the signature verification processing in order to use the vehicle data for at least one of the security measure, the confirmation of the communication status of the vehicle 20, and the management of the state of the vehicle 20. A case where the execution of the signer verification processing is necessary is not limited to the above examples, and may be a combination thereof.

In a case where it is determined in the processing of S905 that the execution of the signer verification processing is necessary, the signature verification device 31 transmits the signature (A901) subjected to the processing of S904 to the key generation management device 11. Next, the key generation management device 11 stores the signature received by the communication unit 101 in the signature storage unit 107 (S906). Next, the key generation management device 11 transmits a receipt notification (A902) for notifying that the signature (A901) has been received to the signature verification device 31 via the network 40.

Next, the signature verification device 31 determines whether or not all the signatures stored in the signature storage unit 305 have been verified (S907). Also in a case where it is determined that the execution of the signer verification processing is unnecessary in the processing of S905, the signature verification device 31 proceeds to the processing of S907. Examples of a method of performing the processing of S907 include a method of deleting the signature for which signature verification has been completed from the signature storage unit 305 and determining whether or not the number of signatures stored in the signature storage unit 305 has become 0. Examples of the method of performing the processing of S907 further include a method of adding a flag to the signature stored in the signature storage unit 305 when signature verification is completed, and determining whether or not the number of signatures to which no flag is added has become 0. The method of performing the processing of S907 is not limited to such methods, and may be a combination thereof.

In a case where it is determined that all the signatures have been verified, the signature verification device 31 ends the signature verification processing (S908). On the other hand, in a case where it is determined that not all the signatures have been verified, the signature verification device 31 returns to the processing of S902. The steps of processing of S902 and S903 may be performed in an arbitrary order.

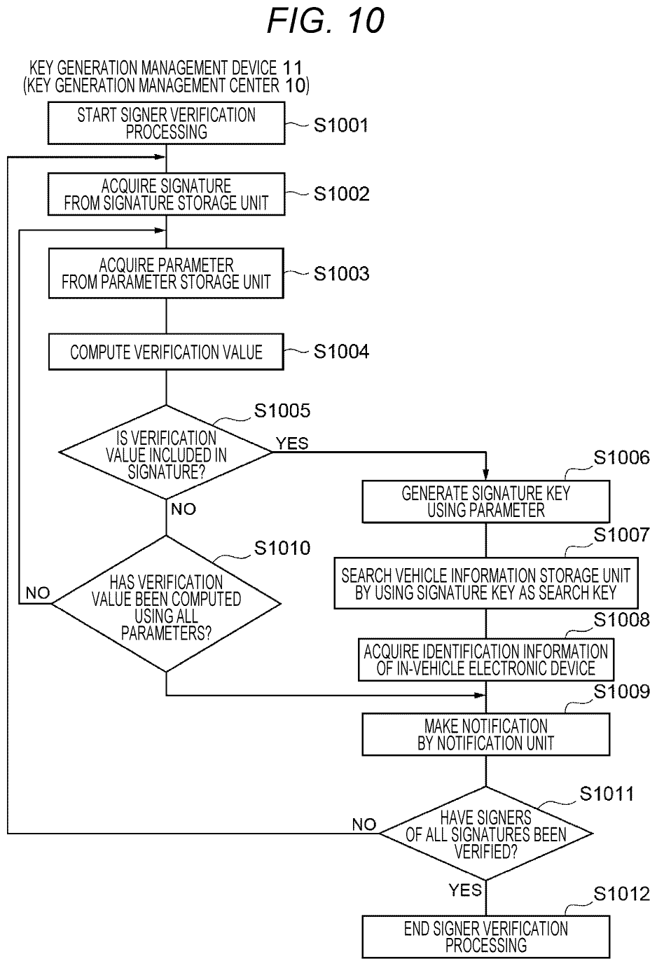

FIG. 10 is a flowchart illustrating details of the signer verification processing of S505 illustrated in FIG. 5.

First, the key generation management device 11 starts the signer verification processing (S1001). The signer verification processing may be started when a signer verification processing start instruction input by a user operation is received, may be started when a predetermined time has elapsed, or may be started when a predetermined number of signatures are stored in the signature storage unit 107. A timing at which the signer verification processing is started is not limited thereto, and may be a combination thereof.

Next, the key generation management device 11 acquires the signature from the signature storage unit 107 (S1002). Next, the key generation management device 11 acquires the parameter from the parameter storage unit 105 (S1003). Next, the key generation management device 11 computes a verification value by using the parameter (S1004). The verification value is a value for specifying the signature key included in the signature. Here, for example, there is a case where the key-generation-related information acquired in the processing of S603 includes the number of verification keys to be generated in order to generate a plurality of verification keys. In this case, the key generation management device 11 computes the verification values as many as the number of generated verification keys by using the parameter included in the key-generation-related information.

Next, the key generation management device 11 determines whether or not the signature acquired in the processing of S1002 includes the verification value (any one of the plurality of verification values in a case where the plurality of verification values are computed) computed in the processing of S1004 (S1005). In a case where it is determined that the computed verification value is included in the signature acquired in the processing of S1002, the key generation management device 11 generates the signature key by using the parameter acquired in the processing of S1003 (S1006). The processing of S1006 may be performed similarly to the processing of S604, or only a part of the processing of S604 in which the verification value included in the signature is used may be performed. The processing of S1006 is not limited thereto.

Next, the key generation management device 11 searches the vehicle information storage unit 108 by using the signature key generated in the processing of S1006 as a search key (S1007). Next, the key generation management device 11 specifies a signature key matching the signature key generated in the processing of S1006 based on a search result. Then, the key generation management device 11 acquires the identification information of the in-vehicle electronic device 21 associated with the specified signature key (S1008). As a result, the key generation management device 11 can specify the in-vehicle electronic device 21 corresponding to the signer who has generated the signature acquired in the processing of S1002.

Next, the key generation management device 11 makes a notification of the identification information of the in-vehicle electronic device 21 acquired in the processing of S1008 by the notification unit 104 (S1009). Examples of a method of performing the processing of S1009 include a method of displaying the identification information of the in-vehicle electronic device 21 on the display of the input/output device 13, but the method of performing the processing of S1009 is not limited thereto.

In addition, in a case where it is determined in the processing of S1005 that the computed verification value is not included in the signature acquired in the processing of S1002, the key generation management device 11 determines whether or not the verification value has been computed using all the parameters stored in the parameter storage unit 105 (S1010). Examples of a method of performing the processing of S1010 include a method of computing the verification value by using the parameters stored in the parameter storage unit 105 in the order of storage and determining whether or not the verification value has been computed using the most recently stored parameter, but the method of performing the processing of S1010 is not limited thereto.

In a case where it is determined that the verification value has not been computed using all the parameters, the key generation management device 11 returns to the processing of S1003. On the other hand, in a case where it is determined that the verification value has been computed using all the parameters, the key generation management device 11 proceeds to the processing of S1009. In this case, the key generation management device 11 makes a notification that the in-vehicle electronic device 21 corresponding to the signer has not been found by the notification unit 104 (S1009). Examples of a notification content in the processing of S1009 in this case include a content indicating that the signature key included in the signature acquired in the processing of S1002 is not a signature key generated by the key generation management device 11, or a content indicating that there is a possibility that the vehicle data to which the signature acquired in the processing of S1002 is added has been falsified. The notification content in the processing of S1009 in this case is not limited thereto, and may be a combination thereof.

Next, the key generation management device 11 determines whether or not the signers of all the signatures have been verified (S1011). Examples of a method of performing the processing of S1011 include a method of adding a flag to the signature stored in the signature storage unit 107 when signer verification is completed, and determining whether or not the number of signatures to which no flag is added has become 0. Examples of the method of performing the processing of S1011 further include a method of setting a status of the signature stored in the signature storage unit 107 to a verified state when signer verification is completed, and determining whether or not the statuses of all the signatures are set to the verified state. The method of performing the processing of S1011 is not limited to such methods, and may be a combination thereof.

In a case where it is determined that the signers of all the signatures have been verified, the key generation management device 11 ends the signer verification processing (S1012). On the other hand, in a case where it is determined that not the signers of all the signatures have been verified, the key generation management device 11 returns to the processing of S1002.

FIG. 11 is a diagram illustrating an example of a user screen 1100 displayed for the user by the key generation management device 11 illustrated in FIG. 1.

The user screen 1100 includes a key generation processing screen 1101 and a signer verification processing screen 1109.

The key generation processing screen 1101 displays a verification key transmission destination field 1102, a generated signature key number field 1103, a parameter field 1104, a status field 1105, a key generation start button 1106, a verification key transmission button 1107, and a signature key transmission button 1108.

For example, a provider name, an address, a mail address, a telephone number, or the like, which is the transmission destination of the verification key, is input to and displayed in the verification key transmission destination field 1102. A content input to and displayed in the verification key transmission destination field 1102 is not limited thereto. The number of generated signature keys is input to and displayed in the generated signature key number field 1103. A random number, a seed, a fixed value, an algorithm name, a variable value, a public value, a secret value, or the like, which is a parameter used for generation of the signature key and the verification key, is input to and displayed in the parameter field 1104. A content input to and displayed in the parameter field 1104 is not limited thereto, and may be a combination thereof. A key generation status is displayed in the status field 1105. Examples of the key generation status displayed in the status field 1105 include newly input, key generation in progress, key generated, signature key transmitted, or verification key transmitted, but the key generation status is not limited thereto, and may be a combination thereof.

The key generation start button 1106 is a button for receiving a pressing operation by the user and starting the key generation processing. The verification key transmission button 1107 is a button for receiving a pressing operation by the user and transmitting the verification key to the transmission destination of the verification key. The signature key transmission button 1108 is a button for receiving a pressing operation by the user and transmitting the signature key.

A user selection field 1110, a signature field 1111, a reception date and time field 1112, a status field 1113, a verification result field 1114, a signer verification start button 1115, a verification result notification button 1116, and an update button 1117 are displayed on the signer verification processing screen 1109.

The user selection field 1110 includes a verification field in which the user inputs a check mark for selecting the signature for which the signer verification processing is to be performed, and a notification field in which the user inputs a check mark for selecting the signature for which a notification of a result of the signer verification processing is to be made. The signature received from the signature verification device 31 is displayed in the signature field 1111. The reception date and time field 1112 displays a date and time when the signature has been received from the signature verification device 31. A display format of the reception date and time field 1112 is, for example, ISO8601, but is not limited thereto. In the status field 1113, a signer verification status is displayed. Examples of the signer verification status displayed in the status field 1113 include new, verified, and notified, but the signer verification status is not limited thereto, and may be a combination thereof. In the verification result field 1114, a result of the signer verification processing is displayed. Examples of the result of the signer verification processing displayed in the verification result field 1114 include the identification information of the in-vehicle electronic device 21 corresponding to the signer, information indicating that the in-vehicle electronic device 21 corresponding to the signer has not been found, information indicating that the signature key is not a signature key generated by the key generation management device 11, and information indicating that there is a possibility that the vehicle data has been falsified. The result of the signer verification processing displayed in the verification result field 1114 is not limited thereto, and may be a combination thereof.

The signer verification start button 1115 is a button for receiving a pressing operation by the user and starting the signer verification processing for the signature with the check mark input in the verification field of the user selection field 1110. The verification result notification button 1116 is a button for receiving a pressing operation by the user and making a notification of the result of the signer verification processing for the signature with the check mark input in the notification field of the user selection field 1110 to the outside of the key generation management device 11. The update button 1117 is a button for receiving a pressing operation by the user and updating each item of the signer verification processing screen 1109. In a case where the signature for signer verification is newly received from the signature verification device 31, when the update button 1117 is pressed, each piece of information regarding the newly received signature is added to the signer verification processing screen 1109. Updating of each item of the signer verification processing screen 1109 may be performed when the update button 1117 is pressed, may be automatically performed periodically, or may be performed by a combination thereof.

Each display item of the user screen 1100 is not limited to the above, and the arrangement of each display item is also not limited to the above.

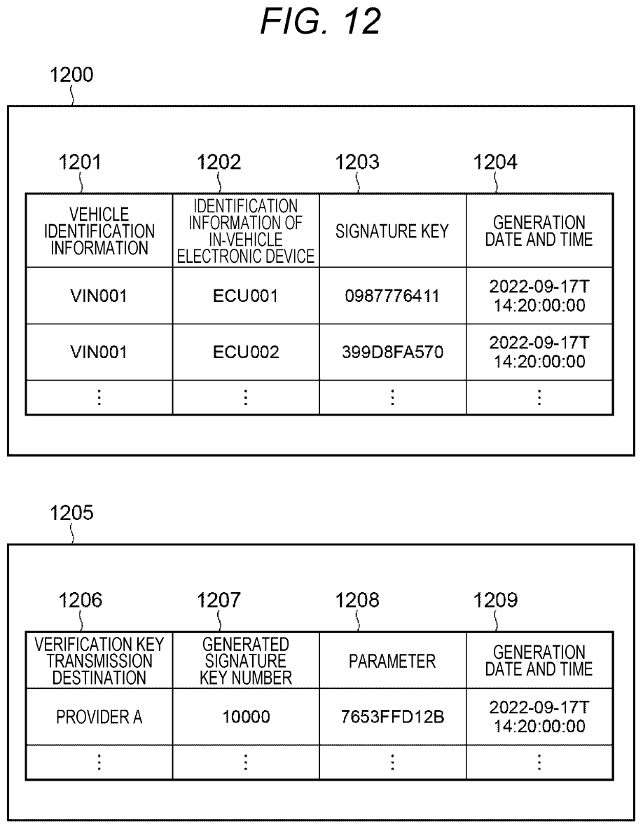

FIG. 12 is a diagram for describing vehicle information 1200 and key-generation-related information 1205 stored in the key generation management device 11 illustrated in FIG. 1.

The vehicle information 1200 includes identification information 1201 of the vehicle 20, identification information 1202 of the in-vehicle electronic device 21, a signature key 1203, and a generation date and time 1204.

The identification information 1201 of the vehicle 20 is, for example, a vehicle identifier such as a vehicle identification number (VIN), but is not limited thereto. The identification information 1202 of the in-vehicle electronic device 21 is an in-vehicle electronic device identifier such as an electronic control unit (ECU) ID, but is not limited thereto. The signature key 1203 is a value of the generated signature key. The generation date and time 1204 is a date and time when the signature key 1203 is generated. A format of the generation date and time 1204 is, for example, ISO8601, but is not limited thereto.

The key-generation-related information 1205 includes a verification key transmission destination 1206, a generated signature key number 1207, a parameter 1208, and a generation date and time 1209.

The verification key transmission destination 1206 is, for example, a provider name, an address, a mail address, a telephone number, or the like, which is the transmission destination of the verification key, but is not limited thereto. The generated signature key number 1207 is the number of generated signature keys. The parameter 1208 is a random number, a seed, a fixed value, an algorithm name, a variable value, a public value, a secret value, or the like, which is a parameter used to generate the signature key and the verification key, but is not limited thereto, and may be a combination thereof. The generation date and time 1209 is a date and time when the verification key was generated. A format of the generation date and time 1209 is, for example, ISO8601, but is not limited thereto.

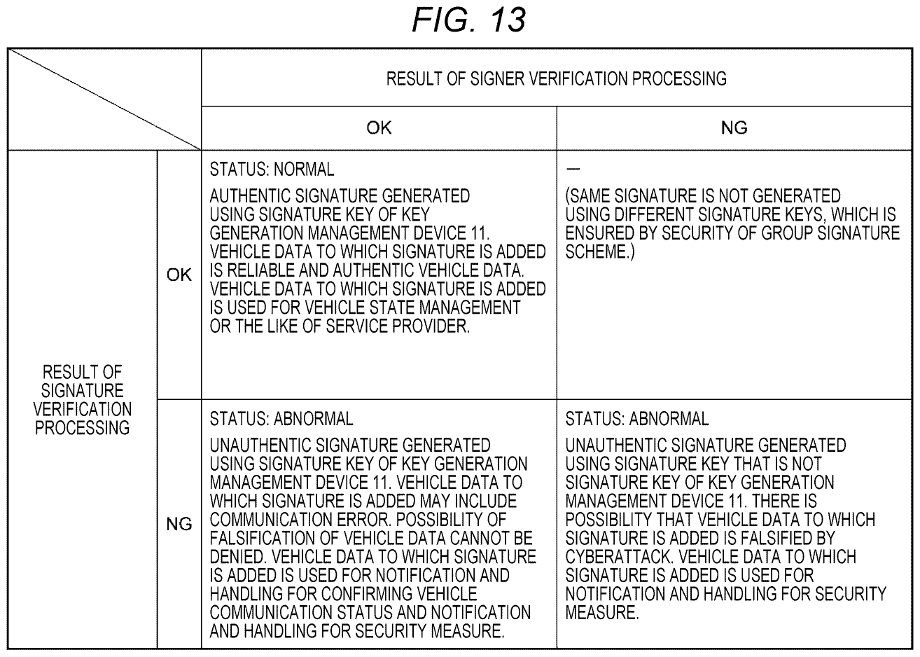

FIG. 13 is a diagram for describing determination processing in the key generation management device 11 based on a relationship between a result of the signature verification processing and a result of the signer verification processing.

In FIG. 13, a result of OK in the signature verification processing indicates that the authenticity of the signature has been verified, and a result of NG in the signature verification processing indicates that the authenticity of the signature has not been verified. In FIG. 13, a result of OK in the signer verification processing indicates that the in-vehicle electronic device 21 corresponding to the signer of the signature has been specified, and a result of NG in the signer verification processing indicates that the in-vehicle electronic device 21 corresponding to the signer of the signature has not been specified.

In a case where the result of the signature verification processing is OK and the result of the signer verification processing is OK, the verification target signature is an authentic signature generated using the signature key of the key generation management device 11. In this case, the signer verification processing unit 103 of the key generation management device 11 determines that the vehicle data to which the signature is added is trusted authentic vehicle data. The vehicle data to which the signature is added is used for vehicle state management or the like of the service provider.

In a case where the result of the signature verification processing is NG and the result of the signer verification processing is NG, the verification target signature is an unauthentic signature generated using a signature key that is not the signature key of the key generation management device 11. In this case, the signer verification processing unit 103 determines that there is a possibility that the vehicle data to which the signature is added has been falsified by a cyberattack. The notification unit 104 notifies the key generation management center 10, the security management department of the service provider, or the like of the determination result. The vehicle data to which the signature is added is used for notification and handling for a security measure.

In a case where the result of the signature verification processing is NG and the result of the signer verification processing is OK, the verification target signature is a signature which is generated using the signature key of the key generation management device 11 and of which the authenticity has not been verified. In this case, the signer verification processing unit 103 determines that there is a possibility that the vehicle data to which the signature is added includes a communication error. The notification unit 104 notifies the department in charge of the service provider that manages the communication status of the vehicle 20, the corresponding vehicle 20, or the like, of the determination result. Furthermore, the signer verification processing unit 103 can also determine that a possibility that the vehicle data to which the signature is added has been falsified cannot be denied. The notification unit 104 notifies the key generation management center 10, the security management department of the service provider, or the like of the determination result. The vehicle data to which the signature is added is used for notification and handling for confirming the communication status of the vehicle 20 and notification and handling for a security measure.

A case where the result of the signature verification processing is OK and the result of the signer verification processing is NG is not assumed. This is because the same signature is not generated using a plurality of signature keys having different values, which is ensured by the inherent security of the group signature scheme.

As described above, the key generation management device 11 of the present embodiment is a device that generates and manages the signature key used for generation of the signature to be added to the vehicle data transmitted from the in-vehicle electronic device 21 to the outside of the vehicle 20. The key generation management device 11 includes the key generation unit 102 that generates the plurality of signature keys having different values and the verification key corresponding to the plurality of signature keys by using the group signature scheme, the communication unit 101 that receives the signature generated by the in-vehicle electronic device 21 using the signature key and subjected to the signature verification processing of verifying the authenticity of the signature by using the verification key, and the signer verification processing unit 103 that performs the signer verification processing of specifying the in-vehicle electronic device 21 corresponding to the signer who has generated the signature on the signature received by the communication unit 101.

As a result, the key generation management device 11 can cause the service provider who performs signature verification to verify the authenticity of the signature generated by the in-vehicle electronic device 21 without providing information that can specify the in-vehicle electronic device 21 that is the signer. Therefore, the key generation management device 11 can make it possible for the service provider to confirm that the vehicle data is authentic vehicle data transmitted from the authorized vehicle 20 that can enjoy the service while making it impossible to specify an individual associated with a transmission source of the vehicle data. On the other hand, in a case where the authenticity of the signature cannot be verified in the signature verification, the key generation management device 11 can specify the in-vehicle electronic device 21 corresponding to the signer based on the signature. Therefore, the key generation management device 11 can specify the in-vehicle electronic device 21 that is the signer based on the digital signature in a case where the authenticity of the digital signature cannot be verified while protecting privacy.

Furthermore, in the key generation management device 11 of the present embodiment, the key generation unit 102 generates the plurality of signature keys by using the plurality of different parameters. In the signer verification processing, the signer verification processing unit 103 specifies which of the plurality of parameters is used to generate the signature key used to generate the signature received by the communication unit 101, thereby specifying the in-vehicle electronic device 21 corresponding to the signer.

As a result, the key generation management device 11 can reliably generate the plurality of signature keys having different values, and can reliably specify which of the plurality of signature keys is used to generate the signature. Therefore, the key generation management device 11 can reliably specify the in-vehicle electronic device 21 corresponding to the signer. Therefore, the key generation management device 11 can reliably specify the in-vehicle electronic device 21 that is the signer based on the digital signature in a case where the authenticity of the digital signature cannot be verified while protecting privacy.

Furthermore, in the key generation management device 11 of the present embodiment, the communication unit 101 receives the signature whose authenticity has not been verified by the signature verification processing. In a case where the in-vehicle electronic device 21 corresponding to the signer has not been specified by the signer verification processing, the signer verification processing unit 103 determines that there is a possibility that the vehicle data to which the signature received by the communication unit 101 is added has been falsified by a cyberattack.

As a result, in a case where a cause of unsuccessful verification of the authenticity of the signature is data falsification by a cyberattack, the key generation management device 11 can cause the key generation management center 10, the security management department of the service provider, or the like to accurately handle the abnormality in which the authenticity of the signature cannot be verified. Therefore, the key generation management device 11 can accurately handle the abnormality in which the authenticity cannot be verified while protecting privacy and enabling specification of the corresponding signer in a case where the authenticity of the digital signature cannot be verified.

Furthermore, the key generation management device 11 of the present embodiment further includes the notification unit 104 that makes a notification of the result of the signer verification processing. The notification unit 104 makes a notification of a determination result indicating that there is a possibility that the vehicle data to which the signature received by the communication unit 101 is added has been falsified by a cyberattack to the outside of the key generation management device 11.

As a result, in a case where a cause of unsuccessful verification of the authenticity of the signature is data falsification by a cyberattack, the key generation management device 11 can cause the key generation management center 10, the security management department of the service provider, or the like to accurately and rapidly handle the abnormality in which the authenticity of the signature cannot be verified. Therefore, the key generation management device 11 can accurately and rapidly handle the abnormality in which the authenticity cannot be verified while protecting privacy and enabling specification of the corresponding signer in a case where the authenticity of the digital signature cannot be verified.

Furthermore, in the key generation management device 11 of the present embodiment, the communication unit 101 receives the signature whose authenticity has not been verified by the signature verification processing. In a case where the in-vehicle electronic device 21 corresponding to the signer has been specified by the signer verification processing, the signer verification processing unit 103 determines that there is a possibility that the vehicle data to which the signature received by the communication unit 101 is added includes a communication error.

As a result, in a case where a cause of unsuccessful verification of the authenticity of the signature is a communication error, the key generation management device 11 can cause the department in charge of the service provider or the like that manages the communication status of the vehicle 20 to accurately handle the abnormality in which the authenticity of the signature cannot be verified. Therefore, the key generation management device 11 can accurately handle the abnormality in which the authenticity cannot be verified while protecting privacy and enabling specification of the corresponding signer in a case where the authenticity of the digital signature cannot be verified.

Furthermore, the key generation management device 11 of the present embodiment further includes the notification unit 104 that makes a notification of the result of the signer verification processing. The notification unit 104 makes a notification of a determination result indicating that there is a possibility that the vehicle data to which the signature received by the communication unit 101 is added includes a communication error to the outside of the key generation management device 11.

As a result, in a case where a cause of unsuccessful verification of the authenticity of the signature is a communication error, the key generation management device 11 can cause the department in charge of the service provider or the like that manages the communication status of the vehicle 20 to accurately and rapidly handle the abnormality in which the authenticity of the signature cannot be verified. Therefore, the key generation management device 11 can accurately and rapidly handle the abnormality in which the authenticity cannot be verified while protecting privacy and enabling specification of the corresponding signer in a case where the authenticity of the digital signature cannot be verified.

Furthermore, the signature verification system 1 of the present embodiment is a system including the key generation management device 11 as described above, and the signature verification device 31 that is connected to the key generation management device 11 and the in-vehicle electronic device 21 via the network 40 and performs the signature verification processing. The key generation management device 11 transmits each of the plurality of signature keys generated by the key generation unit 102 to the in-vehicle electronic device 21, and transmits the verification key generated by the key generation unit 102 to the signature verification device 31. The in-vehicle electronic device 21 generates the signature by using the signature key transmitted from the key generation management device 11, adds the signature to the vehicle data, and transmits the signature added to the vehicle data to the signature verification device 31. The signature verification device 31 performs the signature verification processing on the signature transmitted from the in-vehicle electronic device 21 by using the verification key transmitted from the key generation management device 11, determines whether or not the execution of the signer verification processing is necessary, and transmits the signature for which it is determined that the execution of the signer verification processing is necessary to the key generation management device 11. The key generation management device 11 performs the signer verification processing on the signature transmitted from the signature verification device 31.

As a result, the signature verification system 1 can cause the signature verification device 31 of the service provider that performs signature verification to verify the authenticity of the signature generated by the in-vehicle electronic device 21 without giving information that can specify the in-vehicle electronic device 21 that is the signer. Therefore, the signature verification system 1 can make it possible for the signature verification device 31 to confirm that the vehicle data is authentic vehicle data transmitted from the authorized vehicle 20 that can enjoy the service while making it impossible to specify an individual associated with the transmission source of the vehicle data. On the other hand, in the signature verification system 1, in a case where the authenticity of the signature cannot be verified in the signature verification, the key generation management device 11 can specify the in-vehicle electronic device 21 corresponding to the signer based on the signature. Therefore, the signature verification system 1 can specify the in-vehicle electronic device 21 that is the signer based on the digital signature in a case where the authenticity of the digital signature cannot be verified while protecting privacy.

In the signature verification system 1 of the present embodiment, the key generation management device 11 may be implemented by a plurality of computers connected via a network in the key generation management center 10. The signature verification device 31 may be implemented by a plurality of computers connected via a network in the signature verification center 30. In a case where the plurality of in-vehicle electronic devices 21 have a hierarchical structure in the vehicles 20, the in-vehicle electronic device 21 of the uppermost layer may receive the vehicle data and the signature key from the in-vehicle electronic device 21 of a lower layer, generate the signature, and transmit the signature to the signature verification device 31, or each in-vehicle electronic device 21 may generate the signature, and the in-vehicle electronic device 21 of the uppermost layer may transmit the signature to the signature verification device 31.

Furthermore, the vehicle 20 and the signature verification device 31 may be connected by a wireless communication network or may be connected by a wired communication network. In a case where the signature verification device 31 and the key generation management device 11 receive the plurality of signatures, the signature verification device 31 and the key generation management device 11 may repeat a plurality of sets of the signature verification processing (S504) and the signer verification processing (S505). Alternatively, in this case, the signature verification device 31 and the key generation management device 11 may repeat the steps of processing of S901 to S908 in the signature verification processing (S504) and the steps of processing of S1001 to S1012 in the signer verification processing (S505) a plurality of times for each processing. Alternatively, in this case, the signature verification device 31 and the key generation management device 11 may perform such processing methods in combination.

The present invention is not limited to the above embodiment, and includes various modified examples. For example, the above embodiment has been described in detail in order to describe the present invention in an easy-to-understand manner, and the present invention is not necessarily limited to those having all the described configurations. Further, a part of a configuration of one embodiment can be replaced with a configuration of another embodiment, and a configuration of another embodiment can be added to a configuration of one embodiment. In addition, it is possible to add, delete, and replace other configurations for a part of a configuration of each embodiment.

In addition, some or all of the above-described configurations, functions, processing units, processing means, and the like may be implemented by hardware, for example, by designing with an integrated circuit. In addition, each of the above-described configurations, functions, and the like may be implemented by software using a processor interpreting and executing a program for implementing each function. Information such as a program, a table, and a file for implementing each function can be stored in a recording device such as a memory, a hard disk, or a solid state drive (SSD), or a recording medium such as an integrated circuit (IC) card, a secure digital (SD) card, or a DVD.

In addition, the control lines and the information lines considered to be necessary for the description are illustrated, and not all the control lines and the information lines on the product are necessarily illustrated. In practice, it may be considered that almost all the configurations are connected to each other.

### REFERENCE SIGNS LIST

1 signature verification system
11 key generation management device
101 communication unit
102 key generation unit
103 signer verification processing unit
104 notification unit
20 vehicle
21 in-vehicle electronic device
31 signature verification device
40 network

1. A key generation management device that generates and manages a signature key used for generation of a signature to be added to vehicle data transmitted from an in-vehicle electronic device to an outside of a vehicle, the key generation management device comprising:
a key generation unit that generates a plurality of signature keys having different values and a verification key corresponding to the plurality of signature keys by using a group signature scheme;
a communication unit that receives the signature generated by the in-vehicle electronic device using the signature key and subjected to signature verification processing of verifying authenticity of the signature by using the verification key; and
a signer verification processing unit that performs signer verification processing of specifying the in-vehicle electronic device corresponding to a signer who has generated the signature on the signature received by the communication unit.

2. The key generation management device according to claim 1, wherein
the key generation unit generates the plurality of signature keys by using a plurality of different parameters, and
the signer verification processing unit specifies the in-vehicle electronic device corresponding to the signer by specifying which of the plurality of parameters is used to generate the signature key used for generation of the signature received by the communication unit in the signer verification processing.

3. The key generation management device according to claim 2, wherein
the communication unit receives the signature whose authenticity has not been verified by the signature verification processing, and
the signer verification processing unit determines that there is a possibility that the vehicle data to which the signature received by the communication unit is added has been falsified by a cyberattack in a case where the in-vehicle electronic device corresponding to the signer has not been specified by the signer verification processing.

4. The key generation management device according to claim 3, further comprising a notification unit that makes a notification of a result of the signer verification processing,
wherein the notification unit makes a notification of a determination result indicating that there is a possibility that the vehicle data to which the signature received by the communication unit is added has been falsified by a cyberattack to an outside of the key generation management device.

5. The key generation management device according to claim 2, wherein
the communication unit receives the signature whose authenticity has not been verified by the signature verification processing, and
the signer verification processing unit determines that there is a possibility that the vehicle data to which the signature received by the communication unit is added includes a communication error in a case where the in-vehicle electronic device corresponding to the signer has been specified by the signer verification processing.

6. The key generation management device according to claim 5, further comprising a notification unit that makes a notification of a result of the signer verification processing,
wherein the notification unit makes a notification of a determination result indicating that there is a possibility that the vehicle data to which the signature received by the communication unit is added includes a communication error to an outside of the key generation management device.

7. A signature verification system comprising:
the key generation management device according to claim 1; and
a signature verification device that is connected to the key generation management device and the in-vehicle electronic device via a network and performs the signature verification processing, wherein
the key generation management device transmits each of the plurality of signature keys generated by the key generation unit to the in-vehicle electronic device and transmits the verification key generated by the key generation unit to the signature verification device,
the in-vehicle electronic device generates the signature by using the signature key transmitted from the key generation management device, adds the signature to the vehicle data, and transmits the signature added to the vehicle data to the signature verification device,
the signature verification device performs the signature verification processing on the signature transmitted from the in-vehicle electronic device by using the verification key transmitted from the key generation management device, determines whether or not execution of the signer verification processing is necessary, and transmits the signature for which it is determined that the execution of the signer verification processing is necessary to the key generation management device, and
the key generation management device performs the signer verification processing on the signature transmitted from the signature verification device.
